(19) United States
(12) Patent Application Publication
(10) Pub. No.: US 2018/0190964 A1
(43) Pub. Date: Jul. 5, 2018

(54) ELECTRICAL ENERGY STORAGE MODULE

(71) Applicant: Blue Solutions, Ergue Gaberic (FR)

(72) Inventor: Olivier CAUMONT, Quimper (FR)

(73) Assignee: Blue Solutions, Ergue Gaberic (FR)

(21) Appl. No.: 15/739,071

(22) PCT Filed: Jun. 23, 2016
(86) PCT No.: PCT/EP2016/064510

§ 371 Date: Dec. 21, 2017

(30) Foreign Application Priority Data
Jun. 24, 2015 (FR) 1555794

(51) Int. Cl. H01M 2/30; H01M 2/06; H01M 2/20; H01M 10/42; H01G 11/78; H01G 11/76

(52) U.S. Cl. CPC H01M 2/30; H01M 2/06; H01G 11/76; H01M 10/4207; H01G 11/78; H01M 2/202

(57) ABSTRACT

The invention relates to an electrical energy storage module (1), comprising an enclosure (21) inside which is housed at least one electrical energy storage element (31), said enclosure (21) being closed by a cover (22) provided with two output terminals (41, 42) having positive and negative polarity respectively. Said module is remarkable in that at least one of the two output terminals (41, 42) comprises a flexible cable (410, 420) having an electrically conductive central core surrounded by an electrically insulating sleeve and provided at the free end thereof with an electrical connector (43, 44), and in that said flexible cable (410, 420) passes through the cover (22) in such a way as to present an electrical contact area (413, 423) on the inside face (222) of said cover, said electrical contact area (413, 423) being in electrical contact with said electrical energy storage element (31), and in that the output terminal (43, 41) comprises an electrical connector (44, 43).

### GENERAL TECHNICAL FIELD

The invention is situated in the general technical field of manufacture of an electrical energy storage module, containing at least one electrical energy storage element.

The present invention relates more precisely to such a module equipped with two output terminals, with positive and negative polarity, respectively.

Hereafter in the description and claims, a “module” is either a unitary energy storage element, or an assembly comprising a plurality of energy storage elements, positioned side by side and connected electrically, generally in series. In the second case, such a module makes it possible to supply in a single block the energy storage elements allowing higher voltage and supplying a higher storage capacity than the unitary elements.

In addition to containing energy storage elements, the module generally comprises numerous functional elements ensuring electrical insulation, thermal conduction or the cushioning of said storage elements for example, so as to guarantee proper operation of the module.

Moreover “electrical energy storage element” means, in the scope of the present invention, either a capacitor (i.e. a passive system comprising two electrodes and an insulator), or a supercapacitor (i.e. a system comprising at least two electrodes, an electrolyte and at least one separator) or a battery of the lithium battery type (i.e. a system comprising at least one anode, at least one cathode and a liquid or solid electrolyte between the anode and the cathode).

### STATE OF THE ART

Such a storage module is already known in the state of the art. This module comprises a parallelepiped external envelope inside which are disposed the energy storage elements. These different elements are also interconnected, successively two by two, by a connecting strip, for assembly, generally in series, and the two storage elements situated at the two ends of the series assembly are also each connected by a connecting strip with an appropriate shape respectively to the positive output terminal and to the negative output terminal of the module.

These output terminals allow the connection of the module to a device to be supplied with power.

In known modules of the state of the art, the output terminals, of positive and negative polarity respectively, are fixed, rigid and distant from one another.

Consequently, when it is desired to short-circuit the module, for example during its transportation and prior to its installation on site, it is necessary to add a single cable between the two terminals, for example a metal wire. In the schematic in the appended FIG. 1 can be seen a module M, the two terminals B of which are interconnected by a cable C.

Likewise, when it is desired to assemble several modules in series or in parallel, it is necessary to add a power cable to make the electrical connection between two adjoining modules or with a converter for example. Thus, in the schematic of the appended FIG. 2 can be seen two modules M. The negative terminal of one is connected to the positive terminal of the other by a cable C.

By way of an example, document WO 2014/095365 describes a connection element made of an electrically conductive material of which the two ends are equipped with cylindrical sockets, capable of being engaged respectively around a terminal of the module, for series or parallel assembly of two modules.

Regardless of the state of the art solution selected, it is necessary to use an additional connection cable. This signifies that it must be kept in stock and the stock must be managed and the cable must have the correct diameter, with respect to the intensity of the current that it is desired to have pass through it. In addition, this additional cable generates an incremental cost.

Moreover, the employment of this additional connection cable C generates two additional contact resistances R in the power circuit of the overall system, between each end of this cable and one of the terminals B of a module. The location of these contact resistances is visible in FIGS. 1 and 2. This reduces efficiencies and increases the risk of hot points. This is even more true when the electrical energy storage elements accommodated in the module are supercapacitors, because the problem of contact resistance is paramount with respect to the desired efficiencies.

Finally, the employment of an additional connection cable also has the disadvantage of increasing the number of connection operations during production.

Documents U.S. Pat. No. 4,118,097 and U.S. Pat. No. 5,094,635 describe such modules of which the outside wall is equipped with two fixed rigid output terminals, on each of which are connected by screwing a cable equipped at its free end with an electrical connector.

These modules have the aforementioned disadvantages.

### PRESENTATION DE OF THE INVENTION

The invention has as its objective the mitigation of the aforementioned disadvantages.

It has the aim in particular of supplying an electrical energy storage module which contains at least one electrical energy storage element, and of which the two output terminals, of respectively positive and negative polarity, can be short-circuited or connected to the terminals of other storage modules, without additional parts.

The invention also has as its aim to supply a storage module in which the aforementioned connection operations are simplified and therefore less costly.

To this end, the invention relates to an electrical energy storage module, comprising a housing inside which is accommodated at least one electrical energy storage element, this housing being closed by a cover equipped with two output terminals with positive and negative polarity, respectively.

In conformity with the invention, at least one of the two output terminals comprises a flexible cable which has an electrically conductive central core, surrounded by an electrically insulating sleeve, and which is equipped at its free end with an electrical connector, this flexible cable passes through the cover so as to have an electrical contact zone on the interior face of said cover, this electrical contact zone being in electrical contact with said electrical energy storage element, and the other output terminal comprises an electrical connector.

Thanks to these features of the invention, the flexible cable can be deformed and twisted so as to easily connect its electrical connector, either to the electrical connector of the other terminal of the same module, or to an electrical connector of another module of the same structure, this without additional parts.

In addition, the flexible cable is firmly attached to the module, which avoids losing it, and contact resistances decreased because the interior end of the flexible cable is in direct electrical contact with the energy storage element.

Finally, the electrically conductive central core and the connector are advantageously dimensioned for the module on which they are mounted and are therefore suitable for the intensity of the short-circuit current of said module. This makes it possible to avoid the risk of burns that could be encountered in the state of the art with a cable having too small a diameter.

According to other advantageous and non-limiting features of the invention, taken alone or in combination:
the two output terminals comprise a flexible cable which has an electrically conductive central core, surrounded by an electrically insulating sleeve, and which is equipped at its free end with an electrical connector, and the two flexible cables pass through the cover so as to have an electrical contact zone on the interior face of said cover, this electrical contact zone being in electrical contact with said electrical energy storage element;
the flexible cable of one of the two output terminals or each flexible cable of the two output terminals has sufficient length to allow its electrical connector to be placed in electrical contact with the electrical connector of the other output terminal of the same module, which thus allows ensuring the short-circuiting of said module;
the flexible cable of one of the two output terminals or each flexible cable of the two output terminals has sufficient length to allow its electrical connector to be placed in electrical contact with an electrical connector of an output terminal of another module, which thus allows ensuring series assembly of the two modules;
one of its two electrical connectors is a male connector while the other is a female connector, the two connectors being configured to match one another;
the male connector comprises a plug threaded on its exterior surface and the female connector comprises an internally tapped cavity capable of receiving said threaded plug;
the two electrical connectors are identical;
the connectors are assembled and held in electrical contact with one another using a supplementary assembly means, such as a screw and a nut;
the two output terminals are equipped with supplementary assembly means of the two electrical connectors, such as a floating nut; and
at least one of the two electrical connectors is equipped with a keying pin.

### PRESENTATION OF THE FIGURES

Other features and advantages of the invention will appear from the description which will now be made, with reference to the appended drawings, which represent, by way of indication and without limitation, different possible embodiments of it.

In these drawings:

FIGS. 1 and 2 are schematics showing respectively the short-circuiting of an energy storage module and a series assembly of two of these modules, according to the state of the art,

FIG. 3 is an exploded perspective view showing the different element constituting an embodiment of a module conforming to the invention,

FIGS. 4A and 4B are schematics showing two embodiments of the module conforming to the invention,

FIGS. 5A and 5B are schematics showing the short-circuiting of the modules of FIGS. 4A and 4B,

FIG. 6 is a schematic showing the series assembly of two modules according to FIG. 4A,

FIGS. 7 to 9 show three possible variant embodiments of the output terminals of the electrical energy storage module conforming to the invention, and

FIG. 10 is an exploded perspective view showing different elements constituting a variant embodiment of the module of FIG. 3.

### DETAILED DESCRIPTION OF THE INVENTION

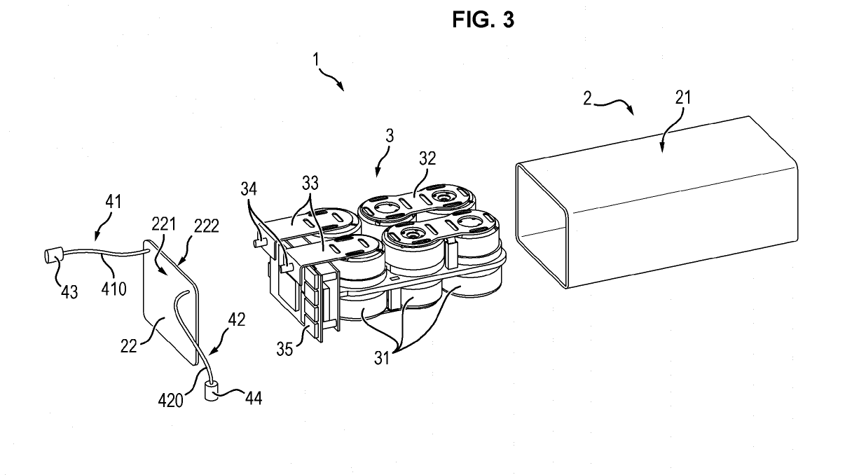

Referring back to FIG. 3, an exemplary embodiment of an energy storage module 1 conforming to the invention can be seen. This module 1 comprises a casing 2 with a preferably parallelepiped shape, which is composed of a housing 21 capable of being closed by a cover 22.

A core of the module 3 comprising several energy storage elements 31, here six in number, is designed to be accommodated inside the casing 2.

The energy storage elements 31 are known to a person skilled in the art and will not be described in more detail here. They are electrically connected, preferably in series, using connecting strips 32 made of an electrically and thermally conductive material, particularly metal.

At both ends of the series assembly, a connecting strip 33 of an appropriate shape connects the last energy storage element 31 to a connection plug 34.

The energy storage elements 31 are also generally connected to at least one electronic board 35.

During assembly of the module 1, the module core 3 is inserted into the housing 21 and the cover 22 is attached to this housing 21 so that the connection plugs 34 are in electrical contact with the output terminals 41 and 42 of the module 1.

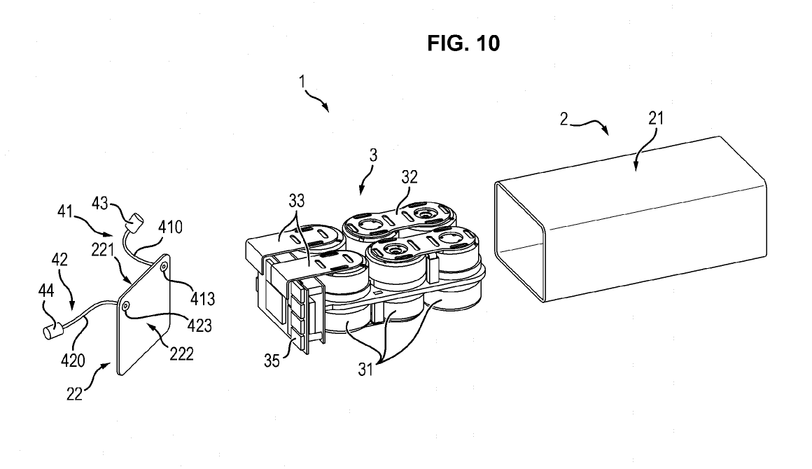

The output terminals 41 and 42 protrude on the external face 221 of the cover 22 and pass through it so as to have an electrical contact zone (not visible in FIG. 3) on the interior face 222 of the cover 22, facing the connection plugs 34. These electrical contact zones 413, respectively 423 of the output terminals 41, 42 are visible in FIG. 10.

The two output terminals have opposite electrical polarities, the positive terminal being referenced 41 and the negative terminal 42.

Other arrangements of the module core 3 and of the casing 2 could be considered without thereby departing from the scope of the invention.

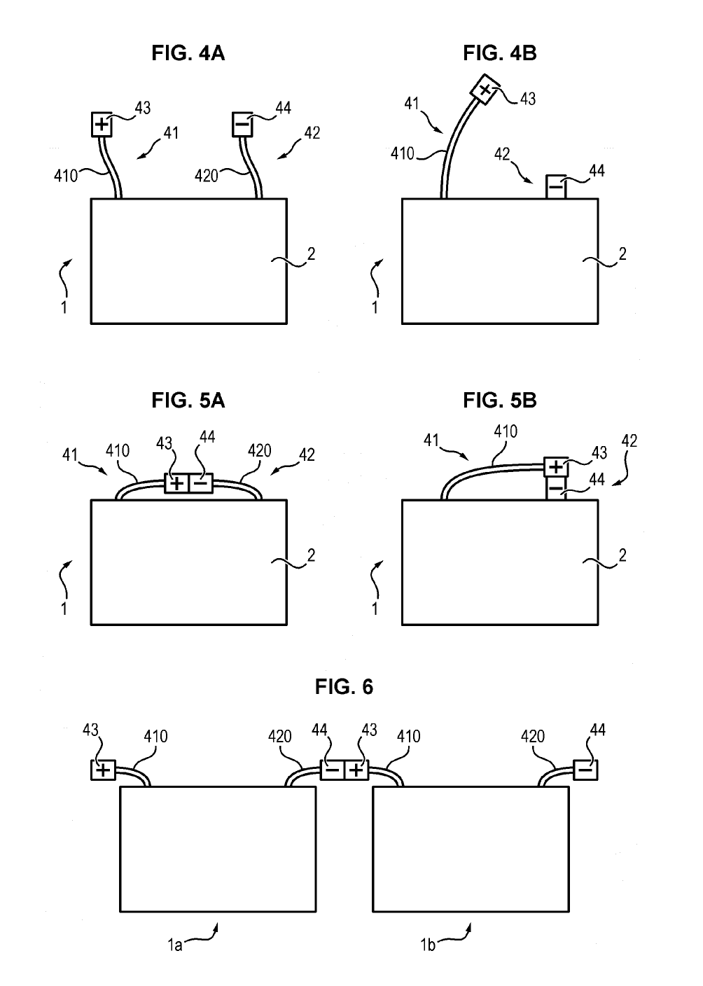

According to a first embodiment of the invention shown in FIG. 4A, each output terminal 41, respectively 42 of the module 1 comprises a flexible cable 410, respectively 420, equipped at its free end, that is at its end opposite that connected to the casing 2, with an electrical connector 43, respectively 44.

According to a second embodiment shown in FIG. 4B, only one of the two output terminals, for example terminal 41 in the figures, comprises a flexible cable 410 equipped with an electrical connector 43. The other output terminal, here terminal 42 in the figure, comprises only an electrical connector 44 but no flexible cable.

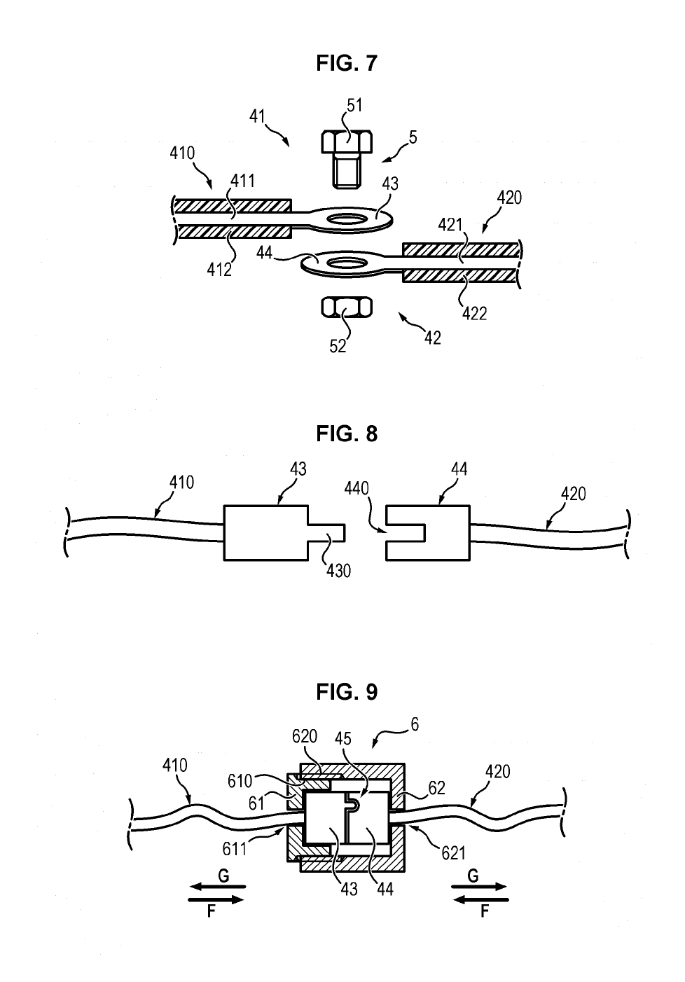

As can be seen only in the section view of FIG. 7, each flexible cable 410, 420 comprises a central core 411, 421 made of an electrically conductive material, consisting for example of a metal wire, this core being surrounded by a sleeve 412, 422 made of electrically insulating material, plastic for example.

The diameter of the central electrically conductive core 411, 421 will advantageously be suitable for the current intensities to be passed through it.

The flexible cables 410, 420 can consist for example of electrical cables or connection wires of the “busbar” type comprising sufficient flexibility to allow easy positioning of an electrical connector facing another electrical connector. The term “flexible” signifies that the cable can be deformed, twisted or curved.

Advantageously, sealed passage of the flexible cable 41, 42 will be provided at the energy storage casing 2, here for example at the cover 22, to avoid any leakage of liquid or gas during handling of the flexible cables.

The variant embodiment shown in FIG. 10 differs from that shown in FIG. 3 in that the connecting strips 33 do not comprise connection plugs 34.

Electrical contact is then achieved directly between the electrical contact zones 413, 423 and the portions of the connecting strips 33 situated facing them, which allows the elimination of a supplementary interface which generates and increase in overall series resistance and thus reduces the overall series resistance of the energy storage module.

According to a first embodiment shown in FIG. 7, the two electrical connectors 43, 44 are identical. For example, they are ring terminals. These two connectors 43, 44 are assembled and held in electrical contact with one another using a supplementary assembly means 5, for example a screw 51 and a nut 52, the screw 51 being capable of being introduced inside the ring of the two ring terminals 43, 44.

According to another variant embodiment shown in FIG. 8, one of the two electrical connectors of the module, connector 43 for example, is a male connector, while the other connector 44 is a female connector, these two connectors being configured to match one another. It will be noted that the “males” or “female” character is independent of the polarity of the output terminal. In the example shown, the male connector 43 comprises a protruding plug 430 and the female connector 44 comprises a cavity 440, capable of receiving said plug 430.

Assembly can be accomplished by simple plugging in or clipping. It is possible to use quick or blade connectors, for example.

According to another variant embodiment, the exterior surface of the plug 430 can be threaded and the interior surface of the cavity 440 can be tapped, using a screw thread corresponding to that of the threaded plug 430, so as to be able to cooperate with it.

Advantageously, the electrical connectors are formed so as to prevent accidental electrical contact so as to avoid any damage to the module and avoid any safety problems for the user.

Also preferably, the connectors 43, 44 must satisfy current safety standards, more particular those which relate to IPXXB and/or IP2X protection levels which define the degree of electrical protection and which impose that the connector be configured to prevent direct access of electrically conductive elements with the finger of an operator. What is meant here by “finger” is the finger of an operator during handling and/or installation of the electrical connector, but also, according to current standards, a “standard” jointed test finger.

Thus, even though it does not appear in the figures, the electrically conductive portions of the connectors can advantageously be protected by a sleeve made of electrically insulating material, formed to allow a deliberate, but not an accidental electrical connection.

According to yet another variant embodiment, it will be noted that the electrical connectors 43, 44, particularly when they are identical, can advantageously be equipped with a keying pin 45 (FIG. 9) preferably of the mechanical type, which allow connection errors to be avoided. Such a keying pin 45 can, for example, be a small protruding element on one of the electrical connectors and a hollow on the other connector.

Such a keying pin 45 thus allows, during manufacture, to avoid inverted voltage connection of the energy storage module on the final test bench. It also allows, in the case of series assembly, avoiding the connection of two electrical connectors of the same polarity, and conversely in the case of parallel assembly, avoiding the connection of two electrical connectors of opposite polarity.

According to a variant embodiment shown in FIG. 9, usable in particular when the electrical connectors 43, 44 cannot be directly assembled mechanically to one another, supplementary assembly means 6, such as a floating nut, can be provided.

This floating nut 6 comprises two portions, namely a male portion 61 threaded at 610 on its exterior surface and a female portion 62 tapped at 620 on its interior face. Each portion 61, 62 has at its rear end, a central opening 611, respectively 621, through which a flexible cable 410, respectively 420, can pass.

The two portions, male and female, 61 and 62, can be screwed together into a locking position (displacement in the direction of the arrows F), thus pressing together the two contact faces of the connectors 43, 44 thanks to their rear end. The two portions, male and female, 61 and 62, can also be unscrewed from one another and then be moved by sliding along the cable 410, respectively 420 (directions of movement shown by the arrows G). In this case, it will be noted that the mechanical tightening and current passage functions are dissociated.

In the variant embodiment with a single flexible cable, one of the portions, male or female, of the floating nut is able slide around the cable while the other is fixed around the connector.

As can be seen in FIG. 5A, advantageously, the length of the flexible cables 410 and 420 is sufficient to allow electrical contact to be established between the electrical connector 43 of the flexible cable 410 with the electrical connector 44 of the other electrical connector 420 of the same module 1, so as to thus provide for the short-circuiting of said module 1.

FIG. 5B illustrates the short-circuiting of the module 1 when this corresponds to the embodiment of FIG. 4b. The length of the single flexible cable 410 is then consequently adapted.

According to another variant embodiment shown in FIG. 6, the length of the flexible cables 410 and 420 can also be sufficient to allow the assembly of two different modules 1 to one another, for example by assembly in series as shown in FIG. 6. In this case, it is observed that the female connector 44 of the first module 1a is electrically connected to the male connector 43 of the second module 1b.

Similarly, and although it is not shown in the figures, the length of the flexible cable of the module with a single cable of FIG. 4B can be adapted to allow series connection with the connector of another module.

These connection steps can be repeated on several successive modules, provided that the male and female connections of each system are equipped with complementary attachment members.

Advantageously, the flexible cables 410, 420 and/or the connectors 43, 44 and/or the module 1 can be equipped with retaining means (clips, clamp, etc.) allowing the attachment of cables or connectors to one of the walls of the module, so as to prevent them being subjected to vibrations, in particular when the modules equip vehicles.

Besides the aforementioned advantages of the invention, it will be noted that, as the electrically conductive central cores 411 and 421 and the electrical connectors 43, 44 are designed for the type of assembly contemplated, this makes it possible to have a correctly dimensioned direct connection between the positive and negative terminals to allow the current to pass between several successive modules.

The connection of the different energy storage modules to each other is simplified and the number of connection operations is limited, which saves time and cost in a production line.

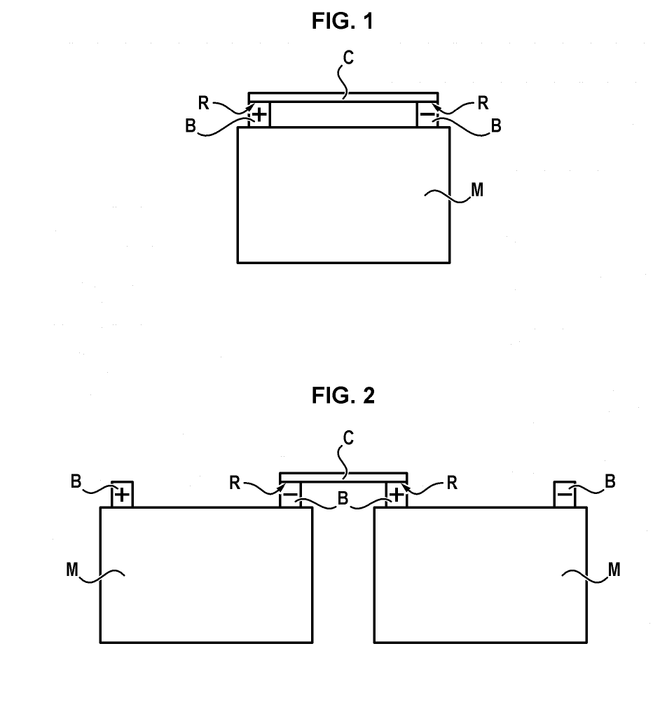

Unlike what was mentioned in connection with the prior art and FIGS. 1 and 2, the solution conforming to the invention allows not adding supplementary cables and minimizes contact resistances and parasitical resistances synonymous with electrical losses. In fact, at each connection, there is then only a single contact resistance instead of two, because the flexible cable is in direct electrical contact by the interior face of the module with the energy storage module contained there.

1. An electrical energy storage module, comprising a housing inside which is accommodated at least one electrical energy storage element, this housing being closed by a cover equipped with two output terminals with positive and negative polarity, respectively, wherein at least one of the two output terminals comprises a flexible cable which has an electrically conductive central core, surrounded by an electrically insulating sleeve and which is equipped at its free end with an electrical connector, in that this flexible cable passes through the cover so as to have an electrical contact zone on the interior face of said cover, this electrical contact zone being in electrical contact with said electrical energy storage element, and wherein the other output terminal comprises an electrical connector.

2. The module according to claim 1, wherein the two output terminals comprise a flexible cable which has an electrically conductive core, surrounded by an electrically insulating sleeve, and which is equipped at its free end with an electrical connector and in that the two flexible cables pass through the cover so as to have an electrical contact zone on the interior face of said cover, this electrical contact zone being in electrical contact with said electrical energy storage element.

3. The module according to claim 1 or 2, wherein the flexible cable of one of the two output terminals or each flexible cable of the two output terminals has sufficient length to allow its electrical connector to be placed in electrical contact with the electrical connector of the other output terminal of the same module.

4. The module according to claim 1 or 2, wherein the flexible cable of one of the two output terminals or each flexible cable of the two output terminals has sufficient length to allow its electrical connector to be placed in electrical contact with an electrical connector of an output terminal of another module.

5. The module according to claim 1 or 2, wherein one of its two electrical connectors is a male connector while the other is a female connector, the two connectors being configured to match one another.

6. The module according to claim 5, wherein the male connector comprises a plug threaded on its exterior surface and in that the female connector comprises an internally tapped cavity capable of receiving said threaded plug.

7. The module according to claim 1 or 2, wherein the two electrical connectors are identical.

8. The module according to claim 1 or 2, wherein the connectors are assembled and held in electrical contact with one another using a supplementary assembly means such as a screw and a nut.

9. The module according to claim 1 or 2, wherein the two output terminals are equipped with supplementary assembly means of the two electrical connectors such as a floating nut.

10. The module according to claim 1 or 2, wherein at least one of the two electrical connectors is equipped with a keying pin.
